(19) United States
(12) Patent Application Publication
(10) Pub. No.: US 2015/0339628 A1
(43) Pub. Date: Nov. 26, 2015

(54) ONLINE SOFTWARE SERVICE SYSTEM AND METHOD

(71) Applicant: ELECTRONICS AND TELECOMMUNICATIONS RESEARCH INSTITUTE, Daejeon (KR)

(72) Inventors: Byeong Thaek OH, Daejeon (KR); Sung Ik JUN, Daejeon (KR)

(73) Assignee: ELECTRONICS AND TELECOMMUNICATIONS RESEARCH INSTITUTE, Daejeon (KR)

(21) Appl. No.: 14/720,318

(22) Filed: May 22, 2015

(30) Foreign Application Priority Data
May 23, 2014 (KR) 10-2014-0062235

(51) Int. Cl. G06Q 10/10; H04L 29/08; G06F 3/0484; H04L 12/24; G06F 3/0481

(52) U.S. Cl. CPC G06Q 10/10; H04L 41/22; G06F 3/04817; G06F 3/04842; H04L 67/1095

(57) ABSTRACT

A virtual workspace providing server for generating a virtual workspace to be provided to a user through a user terminal in an online software service system includes a virtual workspace portal configured to output a software list including a plurality of pieces of software to be provided through a cloud-based service and generate a virtual workspace constituted of software selected by the user, a software list and statistical information manager configured to collect and manage statistical information including at least one of user evaluation information and information about the number of users selecting the software for each of the plurality of pieces of software, a software lifecycle manager configured to collect pattern information in which the software configured in the virtual workspace is used in the user terminal, and a charging manager configured to charge a use fee for the software used by the user using the pattern information.

### CROSS-REFERENCE TO RELATED APPLICATION

This application claims priority to and the benefit of Korean Patent Application No. 10-2014-0062235, filed on May 23, 2014, the disclosure of which is incorporated herein by reference in its entirety.

### BACKGROUND

1. Field of the Invention

The present invention relates to online software service technology, and more particularly, to an online software service system and method for providing software in an online service through the Internet.

2. Discussion of Related Art

An operating system (OS) and a package type application have been installed in user terminals (local terminals) so as to provide users with software. Accordingly, the user can use only hardware and an application(s) dependent on (included in) the OS installed in the user terminal. In order to configure the same working environment in another user terminal, it is necessary to install the same application(s) in the same OS again.

On the other hand, it is easier to configure the same working environment through technology for configuring a working (task) environment by utilizing virtual desktop infrastructure (VDI) technology than through a conventional method of installing a package type application in a local terminal. However, because application modules that are not used by the user should also be licensed in order to use the conventional virtual desktop infrastructure technology, it is difficult to reduce application purchase cost. In addition, there is a disadvantage in that it is difficult to use a working environment using the virtual desktop infrastructure technology in an environment in which a network connection is disconnected or a network service is unavailable.

### SUMMARY OF THE INVENTION

An objective of the present invention is to provide an online software service system and method for configuring a virtual workspace constituted of user-selected software and independently providing a user terminal or an OS with a working environment.

According to one aspect of the present invention for achieving the aforementioned objective, a virtual workspace providing server for generating a virtual workspace to be provided to a user through a user terminal in an online software service system includes: a virtual workspace portal configured to output a software list including a plurality of pieces of software to be provided through a cloud-based service and generate a virtual workspace constituted of software selected by the user; a software list and statistical information manager configured to collect and manage statistical information including at least one of user evaluation information and information about the number of users selecting the software for each of the plurality of pieces of software; a software lifecycle manager configured to collect pattern information in which the software configured in the virtual workspace is used in the user terminal; and a charging manager configured to charge a use fee for the software used by the user using the pattern information.

Also, the virtual workspace providing server according to an exemplary embodiment of the present invention further includes: a connection control and security manager configured to manage security including authentication of the user.

The software lifecycle manager receives a return of software of which a use frequency is low in the user terminal using the pattern information to delete the software from the virtual workspace. Here, the pattern information includes at least one of information indicating a use time and a use pattern in which the software is used in the user terminal.

The virtual workspace portal configures the software list configured by differentiating user-specific priorities of the plurality of pieces of software using at least one of the statistical information and the pattern information.

The virtual workspace providing server according to an exemplary embodiment of the present invention further includes: a web service list manager configured to manage a list of web-based services used to configure the virtual workspace along with the software.

Also, the virtual workspace providing server according to an exemplary embodiment of the present invention further includes: a license manager configured to manage license information including information about a fee per use time for each of the plurality of pieces of software. Here, the charging manager charges a use fee to the user using the license information and the pattern information.

The virtual workspace providing server according to an exemplary embodiment of the present invention further includes: a server provisioner configured to synchronize the virtual workspace with the user terminal. When there is software which is not executed in an OS of the user terminal among the software selected by the user, the server provisioner recommends a virtual engine by which the software is executable to allow the user to select the virtual engine.

According to another aspect of the present invention for achieving the aforementioned objective, a user terminal for providing a user with a virtual workspace generated by a virtual workspace providing server in an online software service system includes: a terminal provisioner configured to receive the virtual workspace through synchronization with the virtual workspace server and provide the user with a plurality of pieces of software constituting the virtual workspace; a configurator configured to customize the software; and a context manager configured to collect status information of the user terminal through migration.

The terminal provisioner predicts power consumption using average power consumption information of each of the plurality of pieces of software constituting the virtual workspace and provides the user with the predicted power consumption. In addition, the terminal provisioner predicts the power consumption using a software use pattern of the user. Further, the terminal provisioner predicts an additionally available battery time further using remaining battery capacity information of the user terminal.

The context manager outputs a return request message of software of which a use frequency is low among the plurality of pieces of software constituting the virtual workspace and returns the software of which the return has been approved by the user to the virtual workspace providing server.

The context manager collects status information including at least one among information about an application which is being used by the user, application component module information, OS information, OS component module information, information about a data file for which a task is in progress, uniform resource locator (URL) information of a currently open website, information about a music file which is being reproduced, application-specific menu position information, and application-specific execution icon position information and transfers the collected status information to the virtual workspace providing server.

According to still another aspect of the present invention for achieving the aforementioned objective, an online software service method for use in a virtual workspace providing server includes: providing a user with a software list including a plurality of pieces of software to be provided through a cloud-based service through a user terminal; generating a virtual workspace constituted of software selected by the user among the plurality of pieces of software; transferring the virtual workspace to the user terminal through synchronization with the user terminal; collecting pattern information in which the software is used in the user terminal; and charging a use fee for the software used by the user using the pattern information.

The providing includes: collecting statistical information including at least one of user evaluation information and information about the number of users selecting the software for each of the plurality of pieces of software and the pattern information including at least one of information indicating a use time in which the software is used and software use pattern information; and generating the software list configured by differentiating user-specific priorities of the plurality of pieces of software using at least one of the statistical information and the pattern information.

Also, the online software service method according to an exemplary embodiment of the present invention further includes: receiving a return of software of which a use frequency is low among the software from the user terminal to delete the returned software from the virtual workspace.

Further, the online software service method according to an exemplary embodiment of the present invention further includes: recommending, when there is software which is not executed in an OS of the user terminal among the software selected by the user, a virtual engine by which the software is executable and receiving a selection input from the user.

According to an exemplary embodiment of the present invention, only software and an OS module selected by a user's need are selectively synchronized and installed online without unconditionally installing package type software purchased by a software user in a user terminal.

According to an exemplary embodiment of the present invention, it is possible to reduce cost for use of paid software by immediately returning software or a module that is not used by the user and charging a use fee for only a time in which the user uses a software product so that only the use fee is paid.

According to an exemplary embodiment of the present invention, the user has an environment in which various software may be independently used for each of hardware and an OS in one user terminal, so that opportunities to use software developed by a producer and opportunities to utilize developed software in a plurality of user terminals possessed by the user increase.

According to an exemplary embodiment of the present invention, guidance is provided so that a user may select low-power software in consideration of average power consumption when software is selected and the same working environment may be configured by restoring a working environment of the user using any terminal in any place.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a system diagram of an online software service system according to an exemplary embodiment of the present invention;

FIG. 2 is a conceptual diagram of a workspace of an online software service system according to an exemplary embodiment of the present invention;

FIG. 3 is a diagram illustrating a process of generating an application of an online software service system according to an exemplary embodiment of the present invention;

FIG. 4 is a block diagram of a virtual workspace providing server of the online software service system according to an exemplary embodiment of the present invention;

FIG. 5 is a diagram illustrating an example of software products displayed on a portal of a virtual workspace providing server according to an exemplary embodiment of the present invention;

FIG. 6 is a block diagram of a user terminal of the online software service system according to an exemplary embodiment of the present invention;

FIG. 7 is a flowchart illustrating a status information collection process of the user terminal according to an exemplary embodiment of the present invention; and

FIG. 8 is a flowchart illustrating a process of returning a software product according to an exemplary embodiment of the present invention.

FIG. 9 is a block diagram illustrating a computer system for the present invention.

### DETAILED DESCRIPTION OF EXEMPLARY EMBODIMENTS

The advantages and features of the example inventive concepts and methods will be apparent from the exemplary embodiments that will be described in more detail with reference to the accompanying drawings. It should be noted, however, that the inventive concepts are not limited to the following exemplary embodiments, and may be implemented in various forms. Because the above-described exemplary embodiments are provided to completely inform those skilled in the art of the scope of the present invention, the present invention is defined by the scope of the claims. The terms used in the present specification are used to describe an exemplary embodiments and are not used to limit the present invention. As in the present specification, a singular form may include a plural form unless the singular form definitely indicated otherwise in the context. Also, in the present specification, the terms “comprise” and/or “comprising” specify existence of components, steps, operations, and/or elements, which are referred to, and do not exclude existence or addition of one or more different components, steps, operations, and/or elements.

Hereinafter, preferred exemplary embodiments of the present invention will be described in detail with reference to the accompanying drawings. First, in the specification, in giving reference signs to components throughout the drawings, it should be noted that like reference signs designate like components even though the components are illustrated in different drawings. Describing the invention herein, when it is considered that detailed description about related known blocks or functions makes the subject matter of the invention unclear, the detailed description may be omitted.

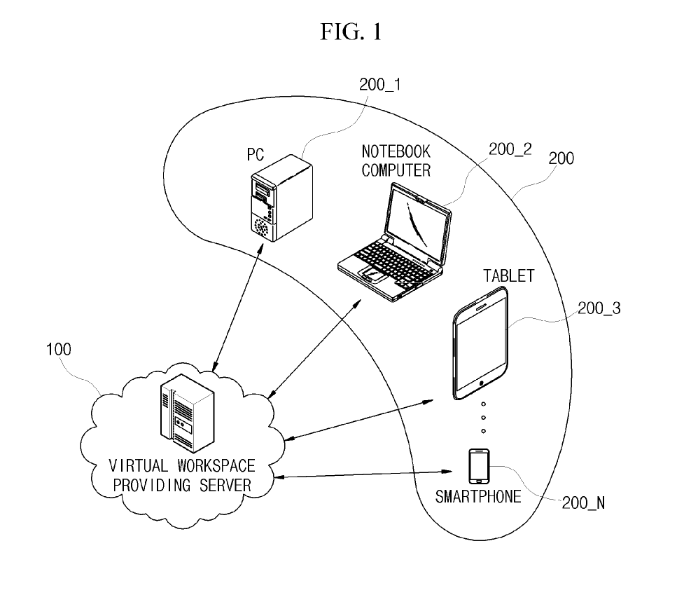

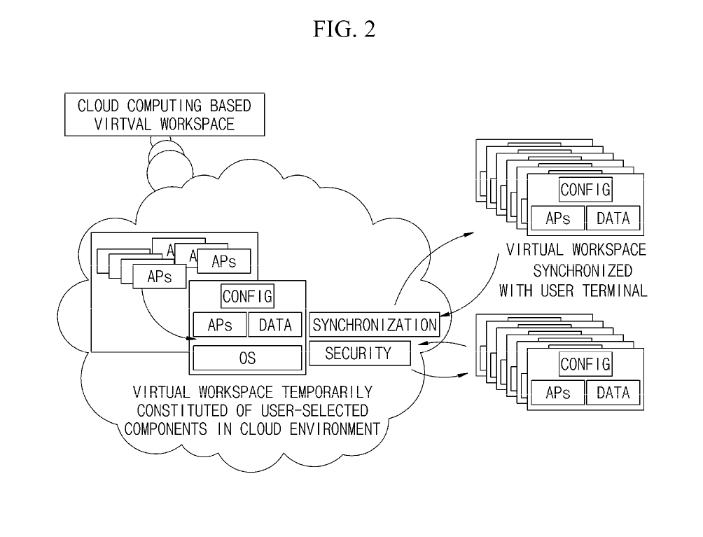

FIG. 1 is a system diagram of an online software service system according to an exemplary embodiment of the present invention, and FIG. 2 is a conceptual diagram of a workspace of an online software service system according to an exemplary embodiment of the present invention.

As illustrated in FIG. 1, the online software service system includes a virtual workspace providing server 100 based on a cloud computing environment and a plurality of user terminals 200 connected to the virtual workspace providing server 100 and configured to receive an online software service.

At this time, the plurality of user terminals 200 are connected to the virtual workspace providing server 100 through a wired/wireless network such as the Internet. For example, each of the plurality of user terminals 200 such as a personal computer (PC) 200_1, a notebook computer 200_2, a tablet 200_3, and a smartphone 200_N used by one user is connected to the virtual workspace providing server 100 via a wired or wireless network.

In addition, as illustrated in FIG. 2, a virtual workspace in which software (a working component(s)) selected for use by the user is customized to be suitable for an individual is generated. In addition, the generated virtual workspace is temporarily stored in the virtual workspace providing server 100. The generated virtual workspace is synchronized with a terminal environment of any one terminal of the plurality of user terminals 200 and the terminal environment with which the virtual workspace is synchronized is customized to be suitable for the user and then used by the user.

Conventionally, software developed by the application developer is mainly installed and used in a local terminal of a user in a package type. On the other hand, the online software service system according to an exemplary embodiment of the present invention provides the user with software through a virtual workspace constituted of user-selected software.

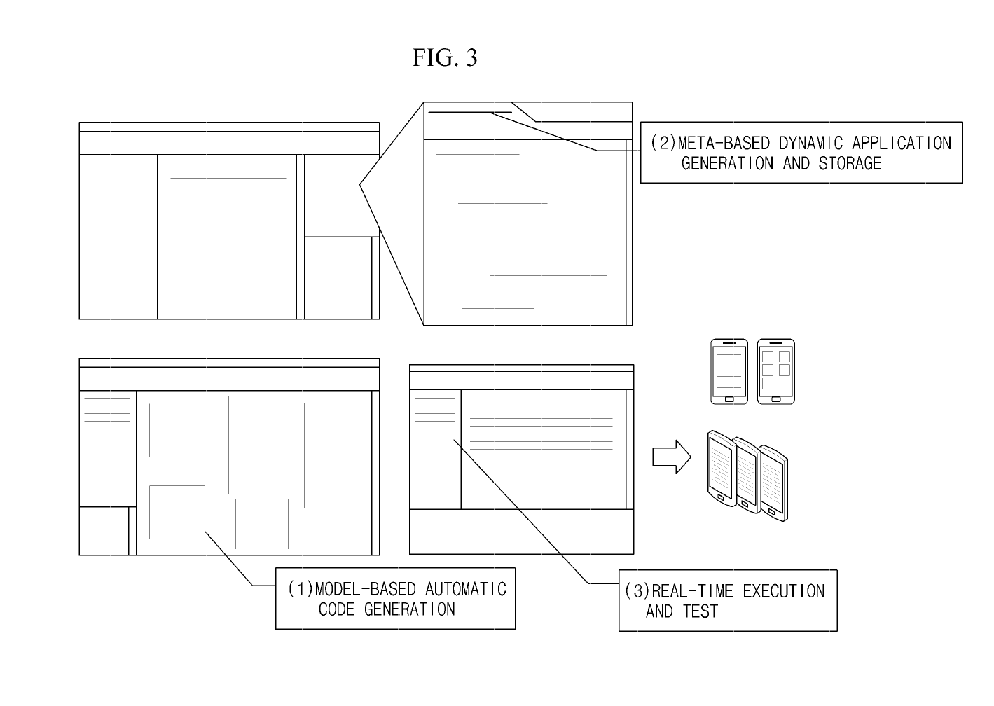

Here, the software may include an application, an application component module, an OS, and an OS component module. At this time, the software (application) provided to the user may be generated through a process illustrated in FIG. 3.

FIG. 3 is a diagram illustrating a process of generating an application of an online software service system according to an exemplary embodiment of the present invention.

Specifically, an application developed by the developer is modularized according to a basic execution code and a function (according to an execution menu of the application) after a model-based application code is generated ((1) Model-based automatic code generation). In addition, one application is stored along with module information so that the application is available in all terminals ((2) Metadata-based dynamic application generation and storage). At this time, a user interface (UI) of the developed application is also developed as an adaptive UI along with meta information. The developed application is executed and tested in real time in a temporary virtual environment and published in a portal (virtual workspace portal) of the virtual workspace providing server 100 ((3) Real-time execution and test).

The application published as described above is approved after being tested by a portal manager again. The approved application may be selected (subscribed) in the virtual workspace portal 120 by the user and used after being synchronized with user terminals.

That is, the online software service system according to an exemplary embodiment of the present invention may add or delete an application module to or from the virtual workspace according to the user's selection. At this time, the deleted application module is deactivated in a corresponding function menu of an application UI.

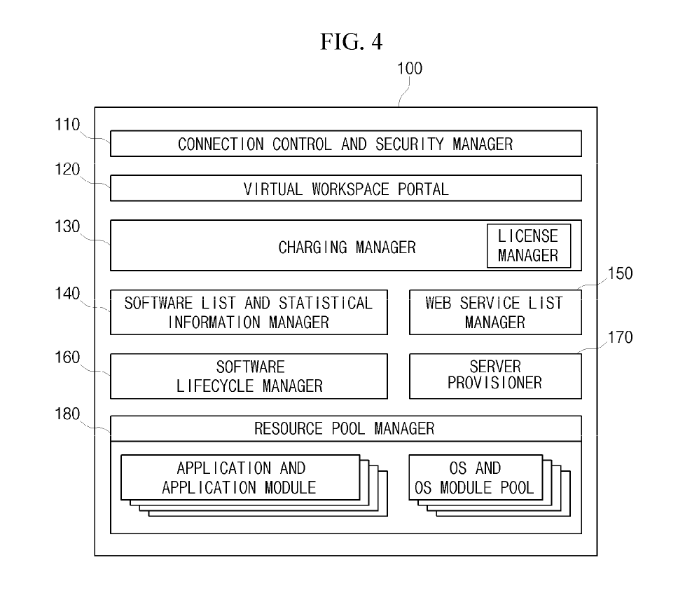

Hereinafter, blocks and operation methods of the virtual workspace providing server 100 and the user terminal 200 for an online software service will be described with reference to FIGS. 4 to 8.

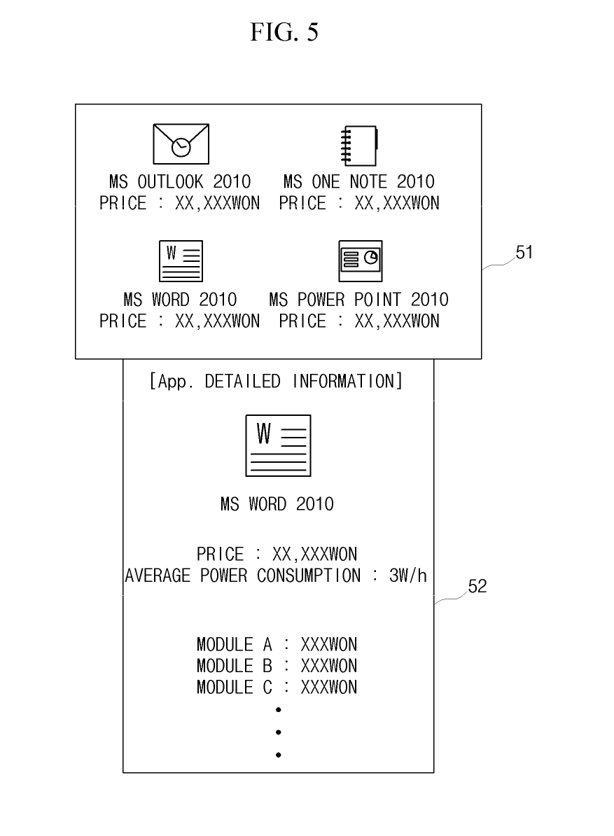

FIG. 4 is a block diagram of a virtual workspace providing server of the online software service system according to an exemplary embodiment of the present invention. FIG. 5 is a diagram illustrating an example of software products displayed on the virtual workspace providing server according to an exemplary embodiment of the present invention.

The connection control and security manager 110 manages the security of all services including user authentication.

The virtual workspace portal 120 provides the user with a working component (software) list of an application and an OS module provided through a cloud-based service, a virtualization engine, a web service, a virtual storage, or the like. A working environment (virtual workspace) is constituted of specific working components selected by the user in the working component (software) list provided as described above and the working environment is synchronized with the user terminal 200 and may be used by the user. All services are managed as metadata along with actual application codes.

After the user first joins the virtual workspace portal 120, the user first performs a process of registering his/her terminal (user terminal 200). User information and terminal information acquired through this process are stored in a ‘user/terminal list and charging information DB.’

When the user has used a paid application, a paid application module, a paid OS, a paid OS module, or the like, a charging manager 130 charges a use fee according to a time in which software is used. At this time, the charging manager 130 uses license information about a fee per use time and the like for each software product and service managed by the ‘license manager.’ In addition, in the case of an OS in which module exchange between OSs is possible, a use fee is charged according to a time in which the exchanged paid OS module is used.

The software list and statistical information manager 140 is connected to a resource pool manager 180 and manages a list of component resources of a virtual workspace of the virtual workspace, evaluations of users, and statistical information such as the number of users selecting software. The statistical information managed as described above is utilized when software products constituting a virtual workspace such as an application in the virtual workspace portal 120 are displayed. When the virtual workspace is generated, the user may select and use paid and free software products desired to be used by the user among displayed software products in consideration of statistical information regardless of his/her own OS.

The software list and statistical information manager 140 stores and manages a current application and a list of components (software) of another working environment in use through selection and synchronization by an individual user.

The web service list manager 150 manages a list of web-based services which are not actual applications, but which are used to configure a working environment along with applications, and provides the web-based service list to the virtual workspace portal 120.

The software lifecycle manager 160 collects and manages pattern information such as a use time and a use pattern(type) in which working environment components (including a detailed module of the application or the OS) to be handled according to a user in the virtual workspace portal 120 are used in the user terminal 200.

In addition, the software lifecycle manager 160 actually receives a return of an application or an application module having a low use frequency in the user terminal 200 through the user or deletes the returned application or application module from the virtual workspace. At this time, the software lifecycle manager 160 may identify a use frequency using pattern information such as a use time and a use pattern according to a software product to be handled in the virtual workspace portal 120 such as the application or the application module or the OS or the OS module according to a user. In addition, use information of the returned application and application module is synchronized with the virtual workspace providing server 100 and utilized as charging information in the charging manager 130.

When application (software) products are displayed by referring to evaluation information, statistical information such as a user work pattern, and pattern information acquired through the software list and statistical information manager 140 and the software lifecycle manager 160, the virtual workspace portal 120 provides display priority differing according to an individual user. For example, as illustrated in FIG. 5, display priority (for example, a display position) of an application is provided to differ according to an individual user when application (software) products are displayed (as indicated by reference sign 51). In addition, when a product list is displayed, a local (host) OS installed in the user terminal 200 and software suitable for virtualization software installed in the user terminal 200 are preferentially displayed.

According to detailed information 52 of specific software, the virtual workspace portal 120 displays a module-specific price of corresponding software along with a basic price of software. In addition, the virtual workspace portal 120 may also provide information such as average power consumption information when the user uses corresponding software by utilizing user terminal information, local (host) OS information, and virtualization software information.

Further, when software is arranged and displayed according to a category, the virtual workspace providing server 100 additionally displays a “low-power software” category along with a software type-specific category and provides support so that low-power software may be utilized to be suitable for an environment of the user terminal 200.

The server provisioner 170 generates a working environment (virtual workspace) using a resource product such as an application selected by the user in the virtual workspace portal 120 in a temporarily configured virtual environment. In addition, the server provisioner 170 performs a function of testing compatibility or the like of the generated virtual interface and synchronizing the virtual workspace with the user terminal 200. At this time, the server provisioner 170 may test and synchronize compatibility according to environment information (a terminal type and spec, an installed OS, configuration setting information, or the like) of the user terminal 200. If there is an application which is not executed in the OS of the user terminal 200 among user-selected applications, a virtualization engine capable of executing the corresponding application may be recommended and selected by the user.

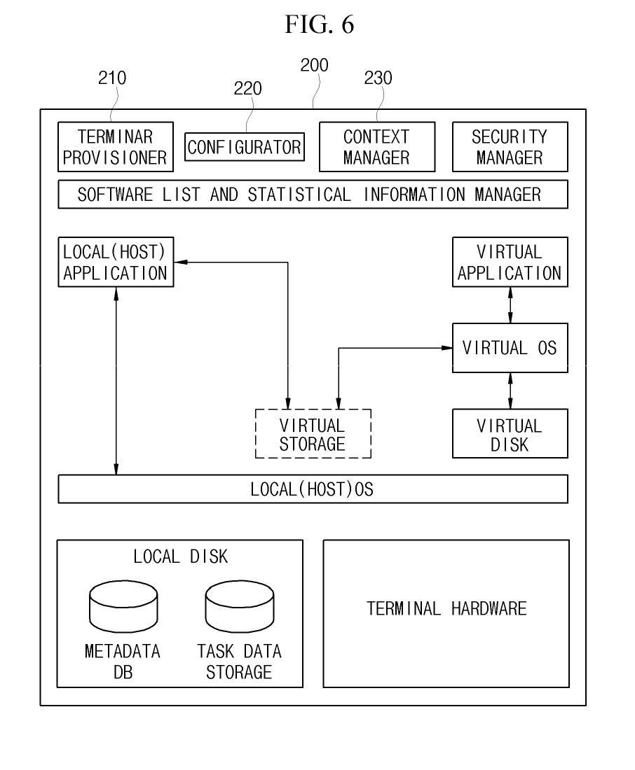

FIG. 6 is a block diagram of a user terminal of the online software service system according to an exemplary embodiment of the present invention.

Here, the user terminal 200 is a user terminal connected to the virtual workspace providing server 100 online and configured to use an online software service. At this time, after the user logs in to the virtual workspace portal 120 of the virtual workspace providing server 100, the virtual workspace is synchronized with his/her own user terminal 200 and the online software service is used.

The terminal provisioner 210 performs a function of synchronizing the virtual workspace generated in the virtual workspace portal 120 of the virtual workspace providing server 100 with the user terminal 200 and providing an environment actually available to the user. At this time, the virtual workspace is generated by combining software resource products such as user-selected applications.

In addition, the terminal provisioner 210 predicts power consumption by utilizing working environment (virtual workspace) information currently configured in the user terminal 200 and statistical information about a software use pattern of the user and provides the predicted power consumption. At this time, the terminal provisioner 210 may predict power consumption using average power consumption information according to each component (software) of the virtual workspace provided from the virtual workspace portal 120. In the case of the user terminal 200 provided with a built-in battery such as a mobile communication terminal, an additionally available battery time is calculated by adding remaining battery capacity information.

A configurator 220 performs a function of performing customization in each application or OS when the user uses a working environment configured in the user terminal 200 or synchronizing working environment information about a UI environment and the like set to be suitable for an individual with the virtual workspace providing server 100. For example, when the user uses a working environment in which a hardware spec is low or a screen size is small as in the mobile communication terminal, synchronization is basically acquired based on an essential module of an application suitable for corresponding hardware. In addition, when the user additionally requires a function while a task is in progress, the configurator 220 performs an additional synchronization process. In the case of the UI, the application is applied to be suitable for a screen size of a corresponding terminal and a display process is performed.

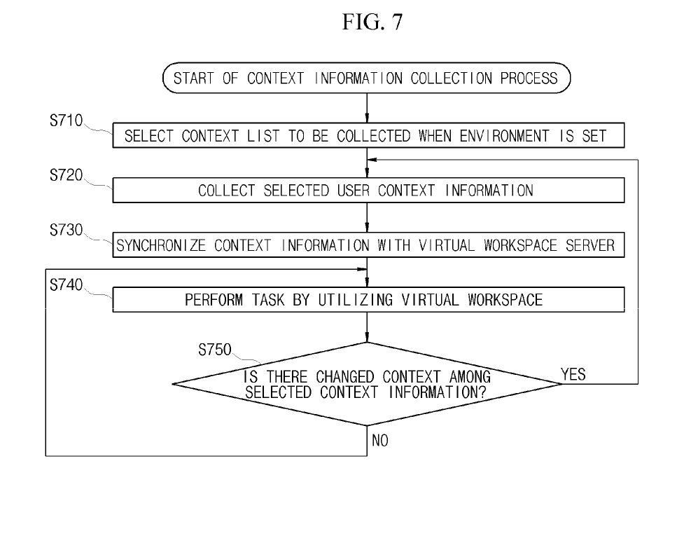

While one task is performed (software is driven) according to the user's selection, the context manager 230 collects context information (status information) of the user terminal 200 through migration and is synchronized with the virtual workspace providing server 100. Specifically, a process in which the context manager 230 of the user terminal 200 collects context information of a user will be described with reference to a flowchart of FIG. 7.

FIG. 7 is the flowchart illustrating a status information collection process of the user terminal according to an exemplary embodiment of the present invention.

When the user sets a virtual workspace environment of the user terminal 200, the context manager 230 selects his/her own working environment information to be synchronized after collecting the working environment information from the user working environment context list in the future (S710). Here, the context information may include at least one of software information used in a current task, information about a data file for which a task is in progress, URL information about a currently viewed website, information about a music file which is being reproduced, information about an application-specific menu position, and information about an application execution icon position. At this time, the software information includes application information, application component module information, OS information, and OS component module information.

The context manager 230 periodically collects context information selected in step S710 (S720) and is synchronized with the virtual workspace providing server 100 (S730). At this time, that is, when the context information is collected and synchronized, information about the user terminal 200 and hardware spec information are also collected and referred to when the context information is utilized in the future.

While the task is in progress by utilizing the virtual workspace according to the user's selection (S740), the context manager 230 collects changed context information again and is synchronized with the virtual workspace providing server 100 when there is changed context information (S750).

When the context information is synchronized with the virtual workspace providing server 100 through the above-described process, the synchronized context information is utilized, an environment in which the user is performing a task is configured without change even when another user terminal among user terminals 200_{—}n is used due to the user's movement thereafter, and the configured environment may be provided to the other user terminal. That is, even when the user terminal 200 is changed, a working environment in which a task is in progress in a previous user terminal is available in another user terminal without change.

The software list and statistical information manager 140 manages an application of the user terminal 200 and manages a component list of another working environment and synchronizes statistical use information with the virtual workspace providing server 100. At this time, the user terminal 200 is a terminal currently being used in synchronization with the virtual workspace providing server 100 in response to the user's selection.

On the other hand, when data of an application to be executed in a local OS or an application to be executed in a virtualized OS is stored, the data is stored using a ‘virtual storage’ of the virtual workspace providing server 100. At this time, a user-selected application as well as data may also be stored and used in the virtual storage instead of a local disk.

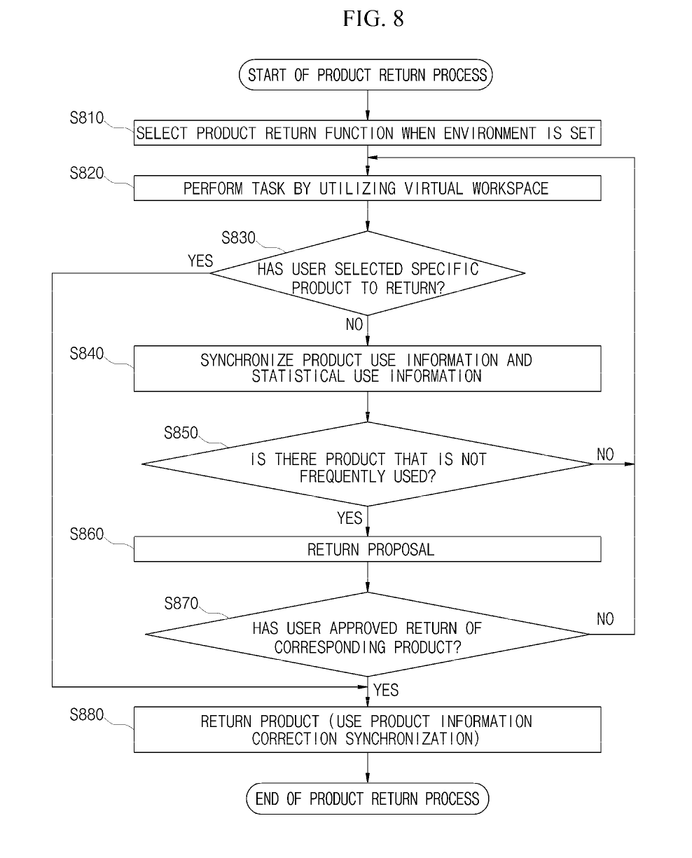

Further, a software product that is not used in the user terminal 200 may be returned. Specifically, a process in which the user terminal 200 returns the software product that is not used in the user terminal 200 will be described using a flowchart of FIG. 8.

FIG. 8 is a flowchart illustrating the process of returning a software product according to an exemplary embodiment of the present invention.

First, a product return function is selected in advance when environment is set (S810). At this time, the product return function may be selected when an environment is set by the user through the configurator 220. That is, in order to reduce a software use fee, a function of returning an unused software product is selected and activated by the user in advance.

After that a software product return process may be performed while a virtual workspace is utilized and a task is in progress (S820). The user terminal 200 identifies whether the user selects a specific software product to return from a software list by determining the non-use of software (S830). When the return of the specific software product is selected, the selected specific software product is deleted from the user terminal 200 and synchronization with a user software use list of the virtual workspace providing server 100 is also acquired (S840). At this time, use information and statistical use information of a software product may be synchronized.

In addition, when there is software or a software module having a low use frequency because the software or software module is not frequently used by the user (S850), the user terminal 200 proposes a return of a software product which is not frequently used to the user (S860). When the return of the proposed software product is approved by the user (S870), the user terminal 200 deletes the software product of the approved return by returning the software product of the approved return and is synchronized with the virtual workspace providing server 100 by also correcting information about a software product in use (S880).

According to an exemplary embodiment of the present invention, a software user pays only a use fee of software used by the user using a method of synchronizing only software or an OS module selected by the user's need online instead of a method in which the software user purchases package type software to install and use the purchased package type software in his/her own terminal. That is, an objective of the present invention is to provide a technical method supported to reduce a fee for use of paid software because the user immediately returns software or a module that is not used and only a fee for a software use time is charged.

In addition, according to an exemplary embodiment of the present invention, an objective of the present invention is to provide support so that a user may select low-power software in consideration of average power consumption when software is selected and the same working environment may be configured in a plurality of user terminals by restoring a working environment of the user using any terminal anywhere.

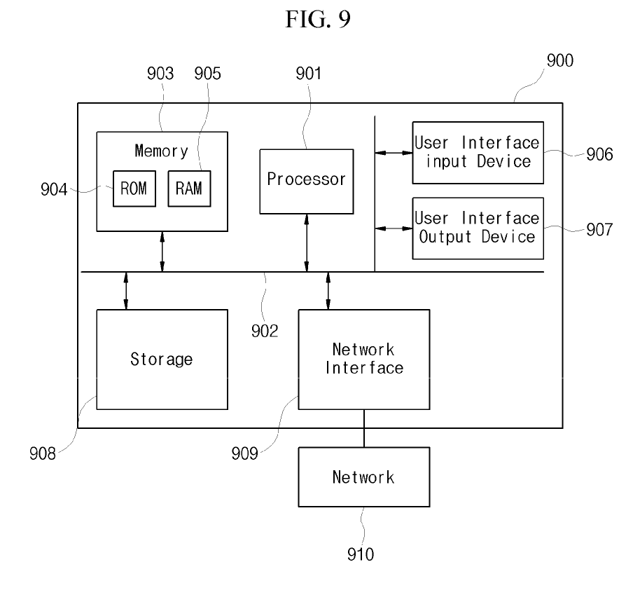

An embodiment of the present invention may be implemented in a computer system, e.g., as a computer readable medium. As shown in in FIG. 9, a computer system 900 may include one or more of a processor 901, a memory 903, a user input device 906, a user output device 907, and a storage 908, each of which communicates through a bus 902. The computer system 900 may also include a network interface 909 that is coupled to a network 910. The processor 901 may be a central processing unit (CPU) or a semiconductor device that executes processing instructions stored in the memory 903 and/or the storage 908. The memory 903 and the storage 908 may include various forms of volatile or non-volatile storage media. For example, the memory may include a read-only memory (ROM) 904 and a random access memory (RAM) 905.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

While the configuration of the present invention has been described through preferred exemplary embodiments of the present invention, it will be understood that the present invention can be easily modified in various embodiments without a change of a technical spirit or essential features of the present invention by a person skilled in the art to which the present invention belongs. Therefore, it should be understood that the exemplary embodiments described above have all been introduced for illustrative purposes and are not limited to the descriptions above. The scope of the present invention is defined by claims described later rather than the detailed description, and it will be understood that meanings and scope of the claims, and all changes or modifications derived from an equivalent concept are included in the scope of the present invention.

What is claimed is:

1. A virtual workspace providing server for generating a virtual workspace to be provided to a user through a user terminal in an online software service system, the virtual workspace providing server comprising:
a virtual workspace portal configured to output a software list including a plurality of pieces of software to be provided through a cloud-based service and generate a virtual workspace constituted of software selected by the user;
a software list and statistical information manager configured to collect and manage statistical information including at least one of user evaluation information and information about the number of users selecting the software for each of the plurality of pieces of software;
a software lifecycle manager configured to collect pattern information in which the software configured in the virtual workspace is used in the user terminal; and
a charging manager configured to charge a use fee for the software used by the user using the pattern information.

2. The virtual workspace providing server according to claim 1, further comprising:
a connection control and security manager configured to manage security including authentication of the user.

3. The virtual workspace providing server according to claim 1, wherein the software lifecycle manager receives a return of software of which a use frequency is low in the user terminal using the pattern information to delete the software from the virtual workspace.

4. The virtual workspace providing server according to claim 1, wherein the pattern information includes at least one of information indicating a use time and a use pattern in which the software is used in the user terminal.

5. The virtual workspace providing server according to claim 1, wherein the virtual workspace portal configures the software list configured by differentiating user-specific priorities of the plurality of pieces of software using at least one of the statistical information and the pattern information.

6. The virtual workspace providing server according to claim 1, further comprising:
a web service list manager configured to manage a list of web-based services used to configure the virtual workspace along with the software.

7. The virtual workspace providing server according to claim 1, further comprising:
a license manager configured to manage license information including information about a fee per use time for each of the plurality of pieces of software.

8. The virtual workspace providing server according to claim 7, wherein the charging manager charges a use fee to the user using the license information and the pattern information.

9. The virtual workspace providing server according to claim 1, further comprising:
a server provisioner configured to synchronize the virtual workspace with the user terminal.

10. The virtual workspace providing server according to claim 9, wherein, when there is software which is not executed in an operating system (OS) of the user terminal among the software selected by the user, the server provisioner recommends a virtual engine by which the software is executable to allow the user to select the virtual engine.

11. A user terminal for providing a user with a virtual workspace generated by a virtual workspace providing server in an online software service system, the user terminal comprising:
a terminal provisioner configured to receive the virtual workspace through synchronization with the virtual workspace server and provide the user with a plurality of pieces of software constituting the virtual workspace;
a configurator configured to customize the software; and
a context manager configured to collect status information of the user terminal through migration.

12. The user terminal according to claim 11, wherein the terminal provisioner predicts power consumption using average power consumption information of each of the plurality of pieces of software constituting the virtual workspace and provides the user with the predicted power consumption.

13. The user terminal according to claim 12, wherein the terminal provisioner predicts the power consumption using a software use pattern of the user.

14. The user terminal according to claim 13, wherein the terminal provisioner predicts an additionally available battery time further using remaining battery capacity information of the user terminal.

15. The user terminal according to claim 11, wherein the context manager outputs a return request message of software of which a use frequency is low among the plurality of pieces of software constituting the virtual workspace and returns the software of which the return has been approved by the user to the virtual workspace providing server.

16. The user terminal according to claim 11, wherein the context manager collects status information including at least one among information about an application which is being used by the user, application component module information, OS information, OS component module information, information about a data file for which a task is in progress, uniform resource locator (URL) information of a currently open website, information about a music file which is being played, application-specific menu position information, and application-specific execution icon position information and transfers the collected status information to the virtual workspace providing server.

17. An online software service method for use in a virtual workspace providing server, the online software service method comprising:
providing a user with a software list including a plurality of pieces of software to be provided through a cloud-based service through a user terminal;
generating a virtual workspace constituted of software selected by the user among the plurality of pieces of software;
transferring the virtual workspace to the user terminal through synchronization with the user terminal;
collecting pattern information in which the software is used in the user terminal; and
charging a use fee for the software used by the user using the pattern information.

18. The online software service method according to claim 17, wherein the providing includes:
collecting statistical information including at least one of user evaluation information and information about the number of users selecting the software for each of the plurality of pieces of software and the pattern information including at least one of information indicating a use time in which the software is used and software use pattern information; and
generating the software list configured by differentiating user-specific priorities of the plurality of pieces of software using at least one of the statistical information and the pattern information.

19. The online software service method according to claim 17, further comprising:
receiving a return of software of which a use frequency is low among the software from the user terminal to delete the returned software from the virtual workspace.

20. The online software service method according to claim 17, further comprising:
recommending, when there is software which is not executed in an OS of the user terminal among the software selected by the user, a virtual engine by which the software is executable and receiving a selection input from the user.
